(19) United States
(12) Patent Application Publication
(10) Pub. No.: US 2026/0256658 A1
(43) Pub. Date: Sep. 3, 2026

(54) WEANING PACIFIER

(71) Applicant: Lizet EZRA EDRI (EDRI), Afula (IL)

(72) Inventor: Lizet EZRA EDRI (EDRI), Afula (IL)

(21) Appl. No.: 19/489,994

(22) PCT Filed: May 30, 2024
(86) PCT No.: PCT/IB2024/055288

§ 371 Date: Dec. 4, 2025

Related U.S. Application Data
(60) Provisional application No. 63/470,899, filed on Jun. 4, 2023.

(51) Int. Cl. A61J 17/00

(52) U.S. Cl. CPC A61J 17/10; A61J 17/001

(57) ABSTRACT

A pacifier and method for weaning a child from use thereof, including: a mouth shield; a teat operationally coupled to the mouth shield, the teat being elastically deformable; a vent member covering an open end of the teat; and a toggle switch disposed over the vent, the toggle switch having a first, open state where vent holes of the vent member are unobstructed, and a second, closed state where the vent holes are covered, the toggle switch being adapted to be moved between the first state and the second state. A pacifier for weaning a child from use thereof, including: a mouth shield; a teat operationally coupled to the mouth shield, the teat having an outer layer and an inner layer, the outer layer formed of a soluble material adapted to dissolve upon contact with liquid.

### FIELD OF THE INVENTION

The present invention relates to a child's pacifier, and, more specifically, to a pacifier for weaning the child off pacifiers.

### BACKGROUND OF THE INVENTION

The field of baby and toddler pacifiers has developed dramatically in the last hundred years in a wide and dramatic way, mainly because of new production technologies, including the use of polymers and silicone.

### SUMMARY OF THE INVENTION

According to the present invention there is provided a pacifier for weaning a child from use thereof, including: a mouth shield; a teat operationally coupled to the mouth shield, the teat being elastically deformable; a vent member covering an open end of the teat such that the vent is in fluid communication with an internal volume of the teat; and a toggle switch disposed over the vent, the toggle switch having a first, open state where vent holes of the vent member are unobstructed, and a second, closed state where the vent holes are covered, the toggle switch being adapted to be moved between the first state and the second state.

According to further features in preferred embodiments of the invention described below in the closed state, air is prevented from exiting the internal volume of the treat, thereby preventing the teat from deforming.

According to still further features in the described preferred embodiments the toggle switch includes a one-way valve such that in the closed state the one-way valve covers the vent holes and allows air to exit from the internal volume of the teat but prevents air from re-entering the internal volume, thereby allowing the teat to deform and preventing the teat from returning to a non-deformed shape.

According to another embodiment there is provided a pacifier for weaning a child from use thereof, including: a mouth shield; a teat operationally coupled to the mouth shield, the teat having an outer layer and an inner layer, the outer layer formed of a soluble material adapted to dissolve upon contact with liquid.

According to further features the inner layer is structured with protuberances, cavities, or protuberances and cavities. According to further features the protuberances or cavities are arranged in irregular patterns.

According to further features the inner layer includes a rough surface.

According to further features the inner layer has a bitter or sour flavoring.

According to further features the outer layer has a first tensile strength, and the inner layer has a second tensile strength, and wherein the first tensile strength is greater than the second tensile strength.

According to further features the second tensile strength is weaker than a tensile strength necessary to maintain a non-deformed shape of a pacifier teat.

According to further features the outer layer covers at least a portion of the teat.

According to further features the outer layer covers a nipple portion of the teat.

According to another embodiment there is provided a method for weaning a child from using any pacifier, the method including: (a) placing a weaning pacifier in a mouth of a child when the weaning pacifier is in a first, regular state; (b) the weaning pacifier transforming from the first, regular state to a second state in which a teat of the pacifier changes shape, texture, or taste while in the mouth of the child.

According to further features the pacifier is transformed from the first state to the second state through chemical reaction of the teat with the mouth of the child.

According to further features the pacifier is transformed from the first state to the second state by mechanical manipulation of a transforming mechanism.

According to further features the method further includes: (c) repeating steps (a) and (b) until the child is weaned from using any pacifier.

### BRIEF DESCRIPTION OF THE DRAWINGS

Various embodiments are herein described, by way of example only, with reference to the accompanying drawings, wherein:

FIG. 1 is a prior art pacifier 10;

FIG. 2 is a side isometric view of the example pacifier 100;

FIG. 3 is a back isometric view of the pacifier 100;

FIG. 4 is a back view of the pacifier 100;

FIG. 5A is a back isometric view of the pacifier 100 with the switch removed and the vent holes in view;

FIG. 5B is an exploded view of the pacifier with some components removed;

FIG. 6A is a view of a pacifier 600 with the outer layer 630 indicated;

FIG. 6B is a view of pacifier 600 with the outer layer removed and the inner layer 640 indicated;

FIG. 7 is a view of an example pacifier 700 with a drooping teat;

FIG. 8 is a flow diagram 800 indicating a process of weaning a child from a pacifier, using a weaning pacifier.

### DESCRIPTION OF THE PREFERRED EMBODIMENTS

The principles and operation of a weaning pacifier according to the present invention may be better understood with reference to the drawings and the accompanying description.

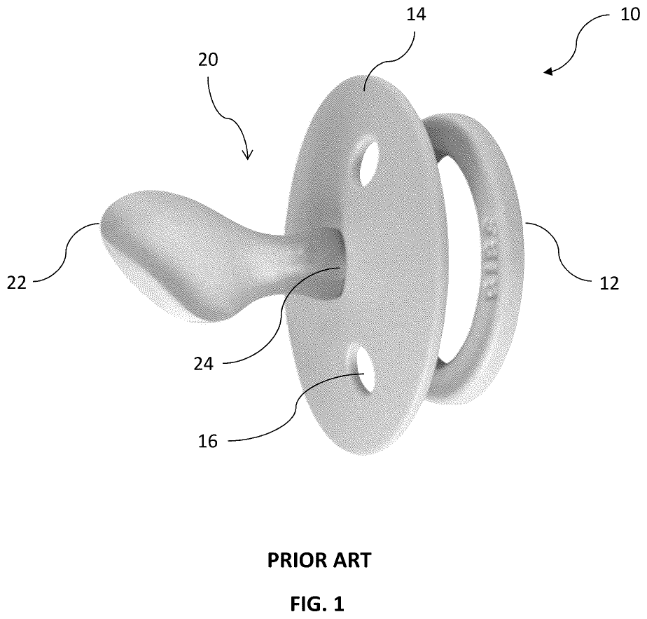

FIG. 1 illustrates a prior art pacifier 10. A pacifier is a rubber, plastic, or silicone nipple substitute given to an infant or toddler to suckle upon between feedings to quiet its distress by satisfying the need to suck when it does not need to eat. Pacifiers normally have three parts, shown in FIG. 1: an elongated teat 20, a handle 12, and a mouth shield 14 which prevents the child from swallowing or choking on it. Many pacifiers do not have a handle. Modern pacifiers have an anatomical nipple 22, at the end of the teat 20, for easy tongue placement. The teat is generally made from soft silicone or natural rubber latex. A base 24 of the teat has a valve (not visible) that lets out air so that the nipple 22 shapes naturally to the baby's oral cavity and depresses if the baby/toddler sucks hard or bites down on the teat and/or nipple. The valve also allows air to reenter the teat so that the shape reforms once the pressure on the teat and nipple is reduced or released. Older or more simplistic pacifiers have a round teat.

In general, the shield 14 curves away from the skin to prevent moisture build-up. Some pacifiers have vent holes 16 which likewise prevent moisture build-up. The handle 12 is designed for grabbing and holding.

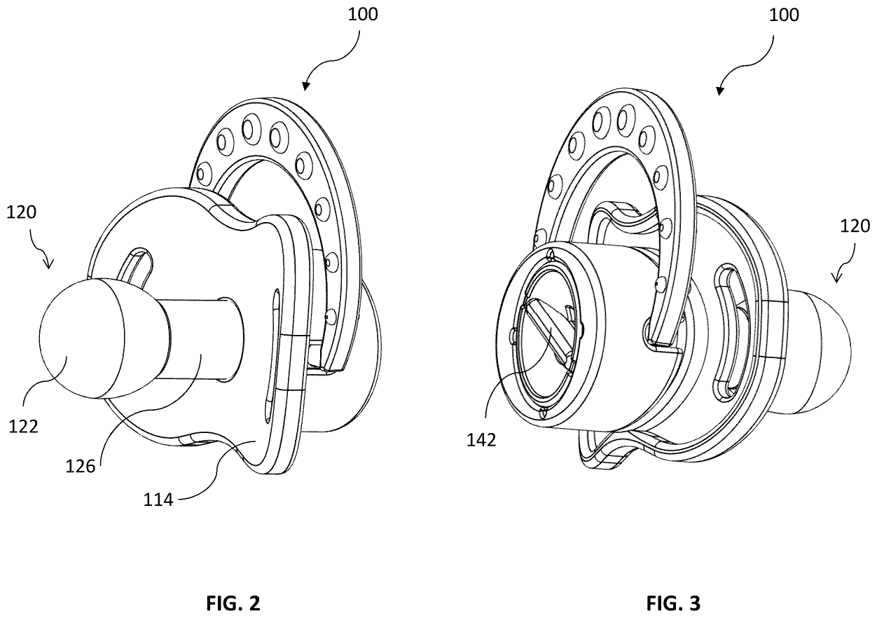

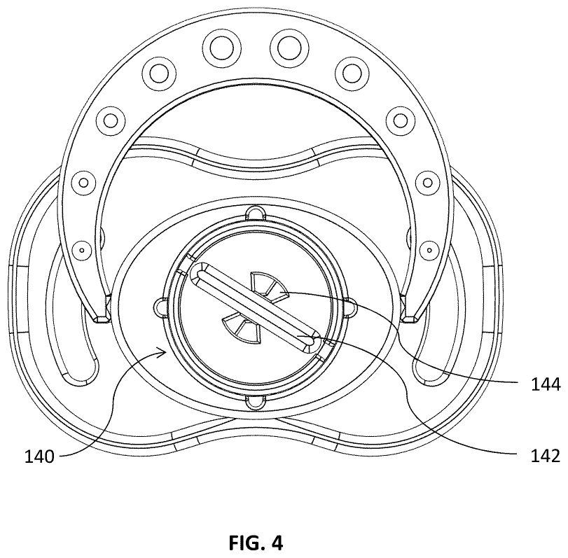

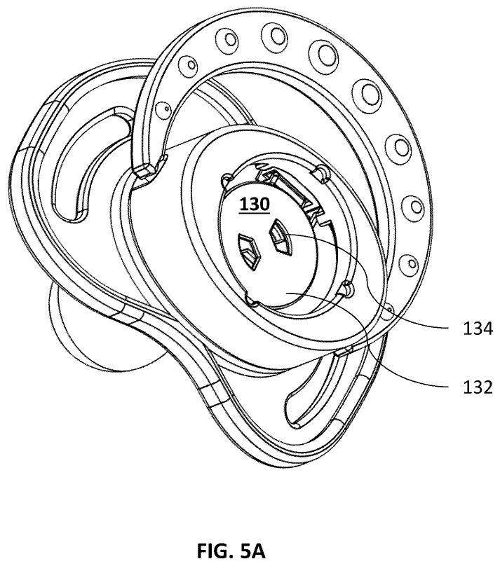

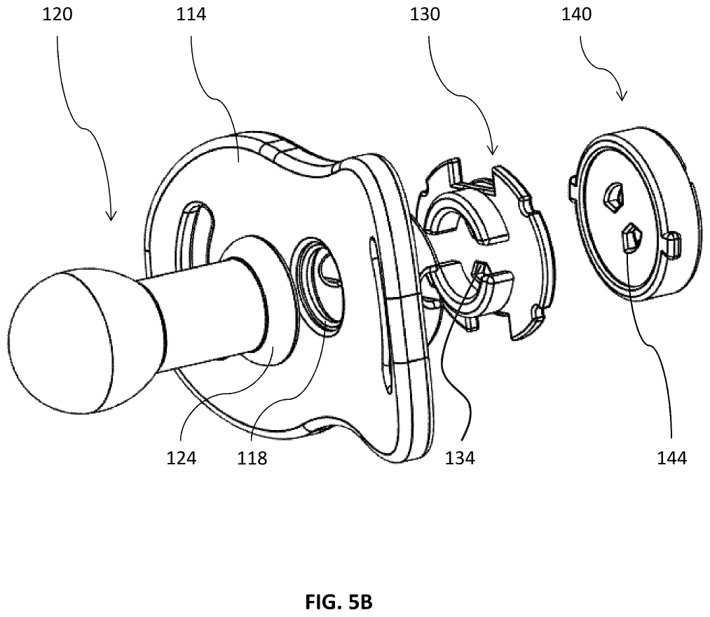

FIGS. 2-5B illustrate various views of an example embodiment of a weaning pacifier 100. FIG. 2 is a side isometric view of the example pacifier 100. FIG. 3 is a back isometric view of the pacifier 100. FIG. 4 is a back view of the pacifier 100. FIG. 5A is a back isometric view of the pacifier 100 with the switch removed and the vent holes in view. FIG. 5B is an exploded view of the pacifier with some components removed.

Referring to FIGS. 2-5B, the pacifier includes a mouth shield 114 and a teat 120 operationally coupled to the mouth shield. The teat is secured to the mouth shield, preventing the child from swallowing the teat. In the depicted embodiment, a base 124 of the teat is a lip 124 (see FIG. 2B) that has a larger diameter than the diameter of an opening 118, preventing the teat from being pulled through the opening by the child. The lip 124 is usually sandwiched against the back of the mouth shield to further secure the teat. The teat is elastically deformable and includes a nipple 122 and stem 126. A vent member 130 (see FIGS. 5A, 5B) covers an open end of the teat.

The vent member 130 includes a cover portion 132 and vent holes 134 disposed in the cover. The vent member (i.e. the vent holes) is in fluid communication with an internal volume of the teat. Air moves in and out of the internal volume of the teat through the vent holes 134. A toggle switch 140 disposed over the vent has a first, open state where the vent holes are unobstructed, and a second, closed state where the vent holes are covered. The toggle switch is adapted to be moved between the first state and the second state, e.g., by rotating a handle 142. For example, handle 142 can be rotated so that openings 144 in the toggle switch 140 either align with the vent holes 134 or do not align with the vent holes.

In some embodiments, the toggle switch, in the closed state, employs a one-way valve that allows air to exit from the internal volume of the teat but prevents air from re-entering the internal volume. The one-way valve configuration allows the teat to deform as the child squeezes the teat (thereby expelling the air from the internal volume of the teat) but prevents air from reentering the teat such that it remains in the deformed shape and is prevented from returning to the original, non-deformed shape. One-way valves are well known in the art and various configurations can be used. One example of a one-valve is a diaphragm valve.

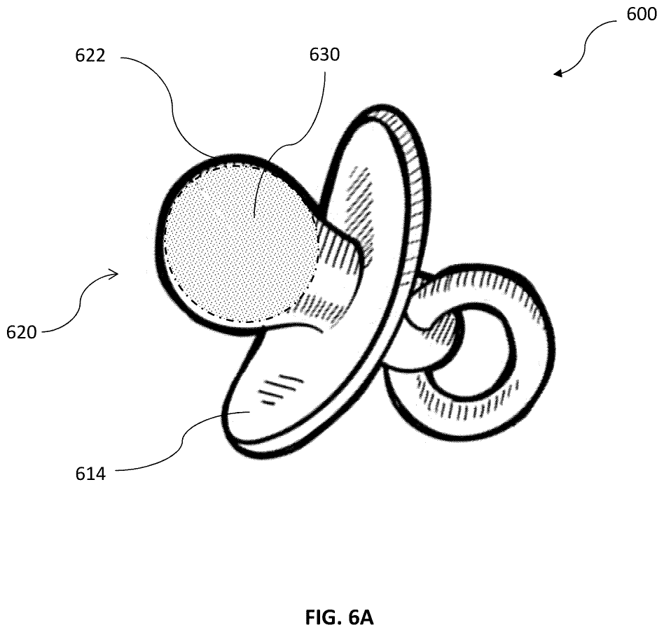

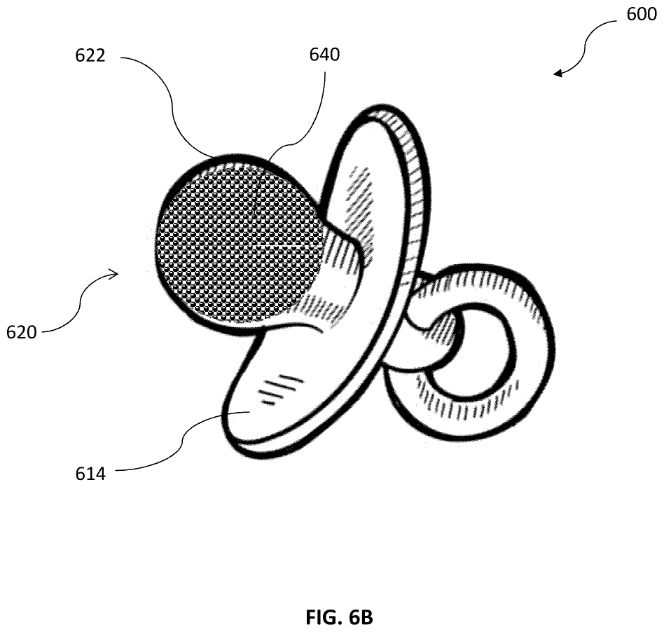

Another possible configuration is shown in FIGS. 6A and 6B. A pacifier 600 is provided for weaning a child from use thereof. The pacifier includes a mouth shield 614 and a teat 620. The teat is operationally coupled to the mouth shield. The teat has an outer layer 630 and an inner layer 640. FIG. 6A depicts pacifier 600 with the outer layer 630 (e.g., of soluble material covering the teat of the pacifier) indicated. FIG. 6B depicts pacifier 600 with the outer layer removed and the inner layer 640 (e.g., the surface of the teat or a layer disposed over the teat surface) indicated.

In embodiments, the outer layer is formed of a soluble material adapted to dissolve upon contact with liquid, such as the child's saliva. In embodiments, pressure, heat, and/or friction may alternatively, or additionally, cause the outer layer to dissolve. In embodiments, the outer layer covers the teat entire. In embodiments, the outer layer only covers a portion of the teat. In embodiments, the outer layer covers a nipple portion 622 of the teat 620.

In embodiments, the inner layer is the surface of the teat itself. In embodiments, the inner layer is a layer of material disposed over a portion of the teat, or over the entire teat. In embodiments, the inner layer 640, beneath the outer layer, is structured with protuberances, cavities, or protuberances and cavities. These non-smooth surface configurations are intended to agitate the child by feeling uncomfortable or unfamiliar, causing the child to reject the pacifier. In some embodiments, the protuberances or cavities are arranged in irregular patterns. In some embodiments, the inner layer includes a rough surface.

In some embodiments, the inner layer has a bitter, sour, or otherwise unpleasant flavoring. This taste is intended to agitate the child by feeling uncomfortable or unfamiliar, causing the child to reject the pacifier.

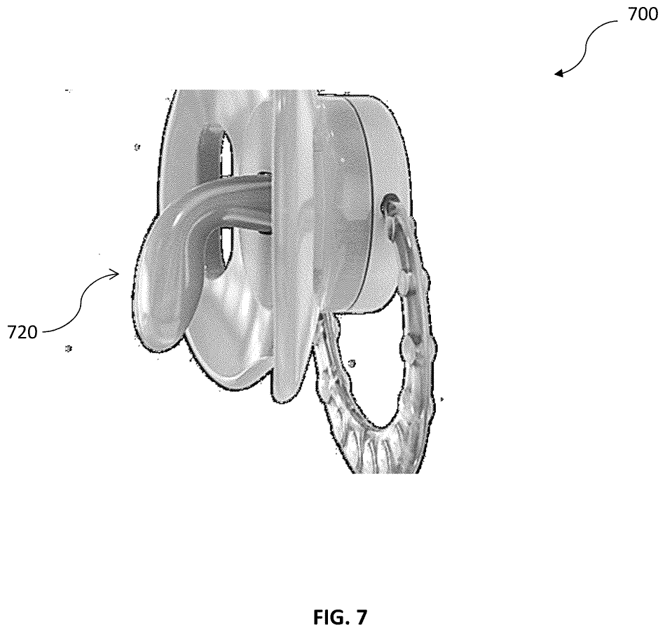

In some embodiment, the outer layer has a first tensile strength, and the inner layer has a second tensile strength. For example, the outer layer may for formed of a material that is sufficiently stiff or rigid to maintain a well-known shape of a pacifier teat, however, once this soluble layer dissolves through contact with the inside of the child's mouth, only the second layer remains. The outer layer's (first) tensile strength is greater than the inner layer's (second) tensile strength. The inner layer has a weaker tensile strength that is insufficient to retain the well-known (non-deformed) teat shape. FIG. 7 depicts an example pacifier 700 with a drooping teat 720, where the material of the teat has a tensile strength that is insufficient to maintain a non-deformed shape of a pacifier teat. In embodiment the drooping teat 720 is initially covered with an outer layer of material that holds the teat in the regular shape and position. The outer layer breaks down or dissolves in the child's mouth. This may be due to saliva, heat, and/or pressure experiences inside the child's mouth. Once the outer layer has broken down or dissolved, the inner layer/base material of the teat has insufficient strength to maintain the posture/shape of a pacifier teat and becomes deformed. In the depicted example, the teat droops in the direction of gravity.

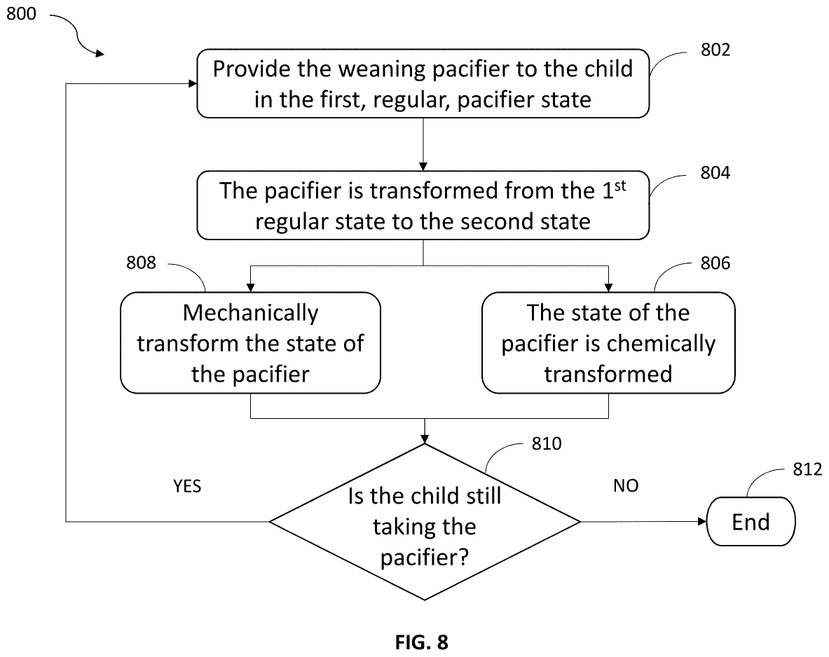

The pacifier is for weaning a child from using the pacifier. FIG. 8 depicts a flow diagram 800 indicating the process of weaning the child from a pacifier, using a weaning pacifier. The method employed is to initially, in step 802, provide a child with a pacifier that has a familiar and comforting shape, texture, taste, etc. In step 804, the familiar and comforting shape and/or texture of the teat of the pacifier changes. In some embodiments, in step 806, this change may be caused by a chemical reaction of the teat with saliva, heat and/or pressure inside the mouth of the child. After a predetermined amount of time, the shape, texture, and/or taste of the pacifier changes while the pacifier is in the child's mouth. Examples of this chemical transformation are discussed above and are to be seem as if repeated here in full. It is noted that these examples are not intended to be limiting by rather to merely provide concrete examples of implementing this process and method.

In other embodiments, in step 808, the change is caused by a mechanical change made to the weaning pacifier whereby the pacifier is changed from one state to another state. In the first state the pacifier has a familiar and comforting shape, texture, and/or taste and in the second state the pacifier has an unfamiliar and/or uncomfortable shape, texture, and/or taste. The mechanical transformation from the first state to the second state can even be made, and is usually made, while the pacifier is in the child's mouth. Examples of mechanical mechanisms for transforming the pacifier from the first state to the second state are discussed above and should be seen as if repeated here in full. The aforementioned notwithstanding, it is made clear that the mechanisms discussed above are merely examples and the invention is not limited to any one mechanism for transforming a pacifier from a first, regular state to a second state in which the pacifier is likely to be rejected by the child and/or ejected from the child's mouth.

The logic being that the change of shape will lead the child to reject (and eject) the pacifier. At step 810, if necessary, i.e., the child is taking the pacifier, then the process is repeated (go back to step 802). After going through the process of a familiar and comfortable pacifier changing into and unfamiliar and/or uncomfortable/unexpected pacifier one or more times, the act of taking the pacifier or sucking on the pacifier will be negatively reinforced (if the process is repeat multiple times) and the child will outright reject the pacifier and thereby conclude the weaning process at step 812.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is

1. A pacifier for weaning a child from use thereof, comprising:
a mouth shield;
a teat operationally coupled to the mouth shield, the teat being elastically deformable;
a vent member covering an open end of the teat such that the vent is in fluid communication with an internal volume of the teat; and
a toggle switch disposed over the vent, the toggle switch having a first, open state where vent holes of the vent member are unobstructed, and a second, closed state where the vent holes are covered, the toggle switch being adapted to be moved between the first state and the second state.

2. The pacifier of claim 1, wherein in the closed state, air is prevented from exiting the internal volume of the treat, thereby preventing the teat from deforming.

3. The pacifier of claim 1, wherein the toggle switch includes a one-way valve such that in the closed state the one-way valve covers the vent holes and allows air to exit from the internal volume of the teat but prevents air from re-entering the internal volume, thereby allowing the teat to deform and preventing the teat from returning to a non-deformed shape.

4. A pacifier for weaning a child from use thereof, comprising:
a mouth shield;
a teat operationally coupled to the mouth shield, the teat having an outer layer and an inner layer, the outer layer formed of a soluble material adapted to dissolve upon contact with liquid.

5. The pacifier of claim 4, wherein the inner layer is structured with protuberances, cavities, or protuberances and cavities.

6. The pacifier of claim 5, wherein the protuberances or cavities are arranged in irregular patterns.

7. The pacifier of claim 4, wherein the inner layer includes a rough surface.

8. The pacifier of claim 4, wherein the inner layer has a bitter or sour flavoring.

9. The pacifier of claim 4, wherein the outer layer has a first tensile strength, and the inner layer has a second tensile strength, and wherein the first tensile strength is greater than the second tensile strength.

10. The pacifier of claim 9, wherein the second tensile strength is weaker than a tensile strength necessary to maintain a non-deformed shape of a pacifier teat.

11. The pacifier of claim 4, wherein the outer layer covers at least a portion of the teat.

12. The pacifier of claim 4, wherein the outer layer covers a nipple portion of the teat.

13. A method for weaning a child from using any pacifier, the method comprising:
(a) placing a weaning pacifier in a mouth of a child when the weaning pacifier is in a first, regular state;
(b) the weaning pacifier transforming from the first, regular state to a second state in which a teat of the pacifier changes shape, texture, or taste while in the mouth of the child.

14. The method of claim 13, wherein the pacifier is transformed from the first state to the second state through chemical reaction of the teat with the mouth of the child.

15. The method of claim 13, wherein the pacifier is transformed from the first state to the second state by mechanical manipulation of a transforming mechanism.

16. The method of claim 13, further comprising:
(c) repeating steps (a) and (b) until the child is weaned from using any pacifier.
